(19) United States
(12) Patent Application Publication
(10) Pub. No.: US 2018/0334103 A1
(43) Pub. Date: Nov. 22, 2018

(54) LEVER TYPE DISPLAY MIRROR

(71) Applicants: Hyundai Motor Company, Seoul (KR); Kia Motors Corporation, Seoul (KR)

(72) Inventors: Nak Kyoung KONG, Seongnam-Si (KR); Jong Min Park, Seoul (KR); Ki Hong Lee, Seoul (KR); Keun Sig Lim, Hwaseong-Si (KR); Chang Ju Kim, Gyeongsan-Si (KR); Yong Hwan Kim, Gyeongsan-Si (KR); Su Young Choi, Gyeongsan-Si (KR); Won Bin Kim, Gyeongsan-Si (KR)

(73) Assignees: Hyundai Motor Company, Seoul (KR); Kia Motors Corporation, Seoul (KR)

(21) Appl. No.: 15/831,196

(22) Filed: Dec. 4, 2017

(30) Foreign Application Priority Data
May 17, 2017 (KR) 10-2017-0060866

(51) Int. Cl. B60R 1/12; B60R 11/02; B60R 1/04; B60R 1/08

(52) U.S. Cl. CPC B60R 1/12; B60R 11/0235; B60R 1/04; B60R 1/086; B60R 2001/1284; B60R 2001/1215; B60R 2300/40; B60R 2300/80; B60R 1/088

(57) ABSTRACT

A display mirror providing a rear image of a vehicle through a mirror and a display panel constituting an inside mirror, may include a housing fixedly located in a windshield glass, a mirror located in the housing, a display panel located on a back of the mirror and receiving a signal of a rear camera to display a rear image, and a tilting lever adjusting an angle of a reflective surface of the mirror to be converted into a day mode and a night mode, wherein a first switch is provided on an end portion of the tilting lever to display the rear image on the display panel, and a second switch is provided to apply power to the display panel as the tilting lever is tilted.

### CROSS-REFERENCE TO RELATED APPLICATION

The present application claims priority to Korean Patent Application No. 10-2017-0060866 filed on May 17, 2017, the entire contents of which is incorporated herein for all purposes by this reference.

### BACKGROUND OF THE INVENTION

### Field of the Invention

The present invention relates to a lever type display mirror. More, it relates to a lever type display mirror, which provides an inside mirror having a display panel on a back of a mirror, and is configured to display a rear image of a vehicle through a display panel by a user's selection through the operation of a tilting lever adjusting a reflective surface of the mirror, a first switch located at the tilting lever, and a second switch located in the inside mirror.

### Description of Related Art

Generally, a windshield glass is mounted on a front of a vehicle where a driver's seat is situated to block wind blowing from the front when the vehicle travels, prevent foreign matter from entering the vehicle, and secure a clear front view. A window glass provided on a side of a front seat including the windshield glass is provided with an inside mirror and an outside mirror to secure a clear rear view and side rear view for a driver.

For example, the inside mirror is referred to as a back mirror or a room mirror, and is observed by a driver to watch a rear situation before changing lanes or making left or right turns or an U-turn. The inside mirror may be used to determine front and back situations.

the inside mirror is attached to an upper portion of an internal surface of the windshield glass in a passenger compartment to allow a driver to recognize a state of a following vehicle and a vehicle-to-vehicle distance when the vehicle travels, thus contributing to safe driving.

Recently, the vehicle additionally has various functions, including an ETC (ELECTRONIC TOLL COLLECTION) function, an ECM (ELECTRONIC CHROMIC MIRROR) function and a REAR CAMERA DISPLAY function. The various functions are included in the inside mirror. The inside mirror may perform its original function as well as various functions, including the ETC (ELECTRONIC TOLL COLLECTION) function, the ECM (ELECTRONIC CHROMIC MIRROR) function and the REAR CAMERA DISPLAY function.

Furthermore, a recent inside mirror is configured to selectively use a display panel and a general mirror. The inside mirror is configured to perform a rear image on the display panel depending on an intensity of illumination introduced into the vehicle or under certain conditions, thus performing the mirror function.

However, when the rear image is displayed on the display panel configured to perform the mirror function, the reflective surface and a display image may overlap each other, so that a clear image may not be obtained.

The information disclosed in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a lever type display mirror, which prevents a rear view reflected on a reflecting mirror from overlapping an image displayed on a display panel, when a rear image is displayed on a display panel.

Various aspects of the present invention are directed to providing a lever type display mirror, which performs a tilting are configured to secure a clear rear view in two modes according to the internal situation of a vehicle.

Various aspects of the present invention are directed to providing a lever type display mirror, which includes a configuration for changing a view mode of an inside mirror, in the case of displaying a display image, thus shielding a user's eyes against a glare.

Objects of the present invention are not limited to the above-mentioned objects, and other objects that are not mentioned herein will be clearly understood by those skilled in the art from the following description. Furthermore, the objects of the present invention may be accomplished by the appended claims and their combinations thereof.

To accomplish the above-described objects of the invention, a lever type display mirror has the following configuration.

Various aspects of the present invention are directed to providing a lever type display mirror including a housing fixedly located in a windshield glass, a mirror located in the housing, a display panel located on a back of the mirror and receiving a signal of a rear camera to display a rear image, and a tilting lever adjusting an angle of a reflective surface of the mirror to be converted into a day mode and a night mode, wherein a first switch is provided on an end portion of the tilting lever to display the rear image on the display panel, and a second switch is provided to apply power to the display panel as the tilting lever is tilted.

In an exemplary embodiment of the present invention, the lever type display mirror may further include a control device located in the housing to drive the display panel.

In another exemplary embodiment of the present invention, the lever type display mirror may further include a wire configured to connect the first switch with the control device, the wire being inserted into a wire passing hole of the tilting lever.

In yet another exemplary embodiment, power may be applied to the display panel, when the tilting lever may be tilted to turn on the second switch.

In yet another exemplary embodiment, the mirror may be converted into the night mode, when the tilting lever may be tilted to turn on the second switch.

In still yet another exemplary embodiment, the signal of the rear camera may be received and the rear image may be displayed on the display panel, when the first and second switches may be turned on.

In a further exemplary embodiment, the lever type display mirror may further include a display window located in a portion of the mirror, wherein the display window may be configured to display a mode of the mirror depending on a position of the tilting lever.

In another further exemplary embodiment, the lever type display mirror may further include an illumination device located in the tilting lever, wherein the illumination device may be turned on in different colors depending in a state of the first switch, in a state where the second switch may be ON.

In yet another further exemplary embodiment, the lever type display mirror may further include a bezel snap-fitted along an opening of the housing.

In yet another further exemplary embodiment, the lever type display mirror may further include an attachment plate located in the housing to fix the mirror, the display panel and the bezel.

In still yet another further exemplary embodiment, the lever type display mirror may further include an ETC (ELECTRONIC TOLL COLLECTION) module located on a side of the housing.

In a still further exemplary embodiment, the mirror may comprise an ECM (ELECTRONIC CHROMIC MIRROR) mirror having an EC function.

In a yet still further exemplary embodiment, the lever type display mirror may further include an illumination detector located in the housing, the illumination detector determining an intensity of illumination introduced into the mirror and controlling a reflectivity of the mirror.

In a yet still further exemplary embodiment, the EC function of the mirror may be released, when the tilting lever is tilted to turn on the second switch.

In a yet still further exemplary embodiment, the display panel may be at least one of LCD, LED, OLED, plasma, and DLP display elements.

Other aspects and exemplary embodiments of the invention are discussed infra.

It is understood that the term “vehicle” or “vehicular” or other similar term as used herein is inclusive of motor vehicles in general including passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The above and other features of the invention are discussed infra.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is an exploded view illustrating a configuration of a lever type display mirror according to an exemplary embodiment of the present invention;

FIG. 2 is a side sectional view illustrating the lever type display mirror according to the exemplary embodiment of the present invention;

FIG. 3 is a block diagram illustrating the lever type display mirror according to the exemplary embodiment of the present invention;

FIG. 4 is a side sectional view illustrating a first switch of the lever type display mirror according to the exemplary embodiment of the present invention;

FIG. 5 is a view illustrating an operation of the lever type display mirror according to the exemplary embodiment of the present invention;

FIG. 6 is a sectional view illustrating an operation of the lever type display mirror according to the exemplary embodiment of the present invention; and

FIG. 7 is a sectional view illustrating an illumination device of the lever type display mirror according to the exemplary embodiment of the present invention.

It may be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Furthermore, terms “panel”, “part”, etc. described herein mean devices for processing at least one function or operation, which may be implemented by hardware, software or a combination of hardware and software.

The invention relates to a lever type display mirror 100. The present mirror includes a mounting 180 connecting an inside mirror 120 with a windshield glass, a housing 110 constituting the inside mirror 120, the mirror 120 provided in the housing 110 to have a reflective surface, and a display panel 130 provided on a back of the mirror 120. The present includes a tilting lever connected to a portion of the mirror 120, a first switch 200 located at an end portion of the tilting lever, and a second switch 300 formed in the housing 110 to apply power to the display panel 130 when the mirror 120 is tilted.

Furthermore, the tilting lever configured to change the inside mirror of the invention to a tilting state may vary in moving direction to perform a tilting operation according to a user's setting. In an exemplary embodiment that will be described below, the inside mirror is configured to perform the tilting function, when the tilting lever is moved to the front of a vehicle.

Moreover, the tilting lever of the invention may be considered as having the same configuration as the first switch.

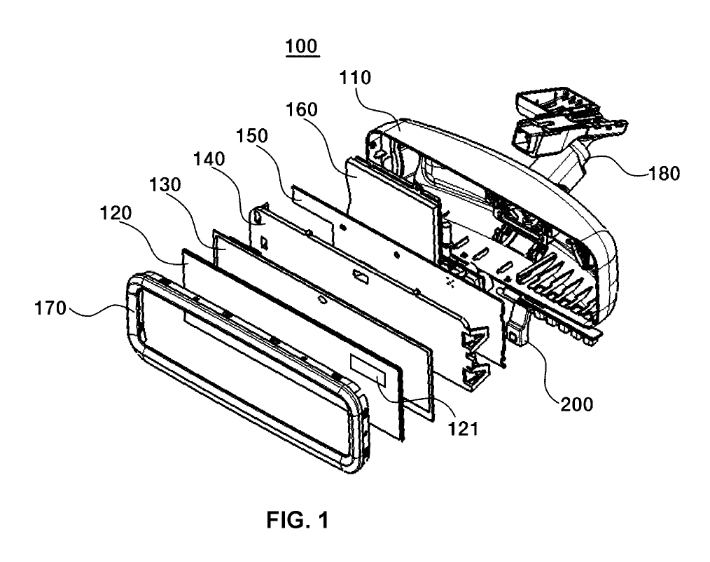

FIG. 1 is a view illustrating the configuration of the lever type display mirror 100 according to an exemplary embodiment of the present invention.

The lever type display mirror 100 located in the windshield glass includes the mounting 180 fixed to the windshield glass. The mounting 180 may be coupled with the housing 110 via a ball bearing 181, so that the housing 110 is movable relative to the mounting 180.

A bezel 170, the mirror 120, the display panel 130, and an attachment plate 140 may be sequentially stacked in the housing 110. Furthermore, a circuit board having a control device 150 may be provided on a back of the attachment plate 140. The circuit board having the control device 150 is tilted to come into contact with the second switch 300.

The bezel 170 may be snap-fitted into an opening of the housing 110 which is configured to surround an external portion of the mirror 120, and may be fastened to the attachment plate 140 in the housing 110 via a screw. Thus, the bezel is fixedly coupled to an internal to the housing 110 to protect the mirror 120 and the display panel 130 from external shocks.

The display panel 130 of the invention may be at least one of LED, OLED, plasma, and DLP display elements. Furthermore, the mirror 120 includes an electronic chromic mirror (ECM), and is controlled to perform a dimming function. An illumination detector located at the housing 110 determines an intensity of illumination introduced into the mirror 120, and a control device 150 controls a reflecting amount of the mirror 120 performing an EC (electronic chromic) function depending on a determined illumination intensity, thus shielding a user's eyes against a glare.

The second switch 300 fixedly provided on the mounting 180 in the rear of the circuit board is configured to apply power to the display panel 130, when the mirror 120 is tilted through a tilting lever. Thus, the second switch may adopt various on/off switches.

That is, the second switch 300 may maintain an off state before the tilting lever is rotated to perform a tilting operation. Thus, it is configured to provide a clear rear view through the reflective surface of the mirror 120 located in an outermost portion of the opening of the housing 110, without applying power to the display panel 130.

An Electronic Toll Collection System (ETC) module 160 may be provided on an outside of the housing 110, and an opening-shaped card insertion hole may be formed in a side of the housing 110.

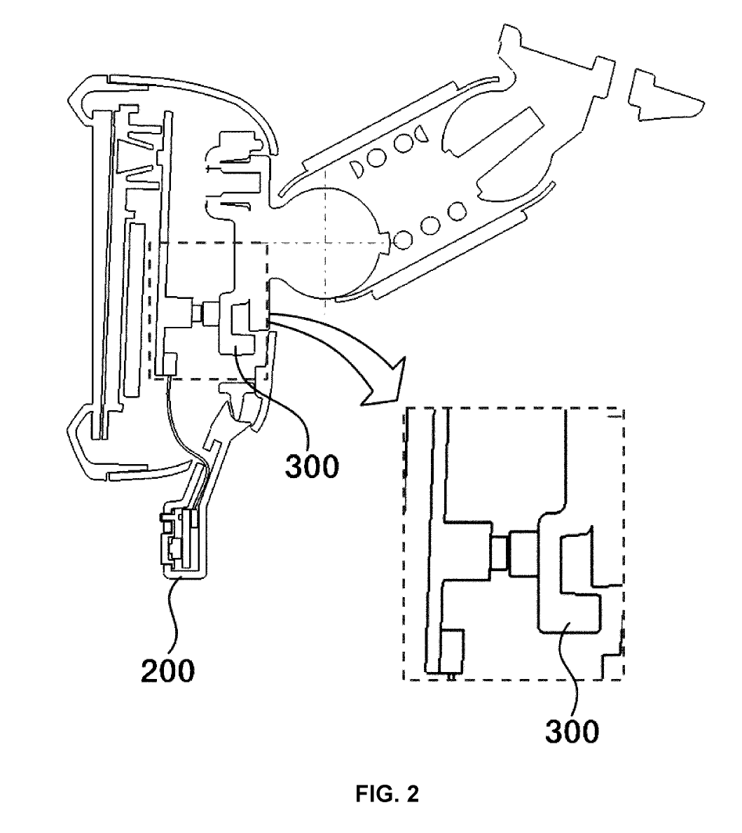

FIG. 2 is a side sectional view illustrating the lever type display mirror 100 according to the exemplary embodiment of the present invention.

As illustrated in FIG. 2, the mounting 180 and the housing 110 may be fastened to each other via the ball bearing 181, and the housing 110 may be tilted relative to a rotation shaft located in the bearing 181 coupled with the mounting 180.

The tilting lever is configured to protrude from a lower surface of the housing 110 and rotate forwards and backwards relative to the inside mirror 120. The tilting lever is configured to perform the tilting function of the housing 110 by coupling with the housing 110.

The first switch 200 is located at an end portion of the tilting lever, and is electrically connected to the control device 150 located in the housing 110. The control device 150 and the first switch 200 may be electrically connected to each other via a wire 220, and the wire 220 may be inserted into a wire passing hole 230 of the tilting lever.

When the second switch 300 is changed to an ‘ON’ state and then the first switch 200 is turned on, an image captured by a rear camera is displayed on the display panel 130. The image captured by the rear camera is corrected through the control device 150 to be equal to a view reflected on the mirror 120.

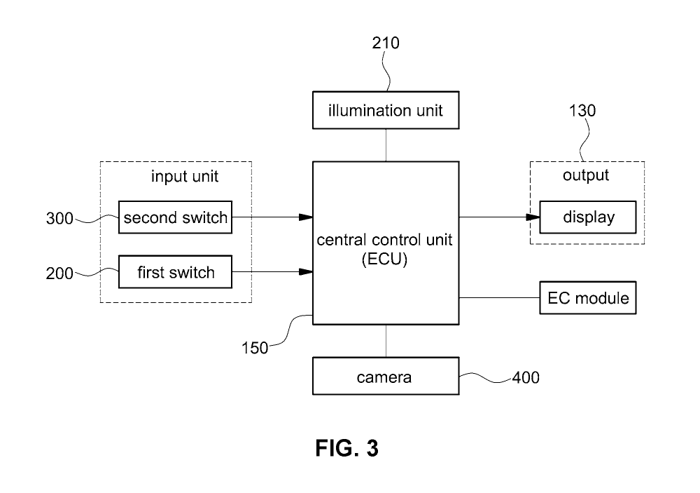

FIG. 3 illustrates the configuration of the lever type display mirror 100 according to the exemplary embodiment of the present invention.

The control device 150 provided in the housing 110 is configured to control the function of the illumination device 210, the rear camera, the display panel 130 and the EC in response to a switch signal as the first switch 200 and the second switch 300 are turned on or off.

The ON/OFF state of the second switch 300 is set as the tilting lever rotates. When the tilting lever is located at a rear end portion of the vehicle and thus the second switch 300 is in the OFF state, a day mode is implemented to secure a clear rear view through the mirror 120, and the EC function of the mirror 120 is activated.

When the tilting lever rotates and moves to the front of the vehicle by a user's manipulation, the second switch 300 is set to the ON state. In the instant case, the mirror is changed into a night mode so that the rear view reflected on the mirror 120 has a virtual image, and is configured to apply power to the display panel 130 and the illumination device 210. Furthermore, in the state where the second switch 300 is in the ON state, the EC function of the mirror 120 is changed to an inactive state.

According to an exemplary embodiment of the invention, when the second switch 300 maintains the ON state and the first switch 200 is in the OFF state, the LED illumination located in the illumination device 210 is turned on to maintain a white color.

By contrast, when both the second switch 300 and the first switch 200 are in the ON state, the illumination device 210 is turned on to maintain a green color, and the display function is activated to display the image captured by the rear camera on the display panel 130.

That is, the second switch 300 is configured to apply power to the display panel 130, and the display function is activated to display the image on the display panel 130 to which power is applied when the first switch 200 is changed in the ON state.

The control device 150 controls the reflectivity of the mirror 120 including the EC function in the day mode to perform the dimming function. When the display panel 130 is activated depending on the conditions of the first switch 200 and the second switch 300, the distortion of the image captured by the rear camera is corrected and then the image is displayed on the display panel 130.

Furthermore, the control device 150 is configured to control whether the illumination device 210 and a display window 121 are turned on depending on the state of the first switch 200 and the second switch 300, and to set a color of the LED which is turned on.

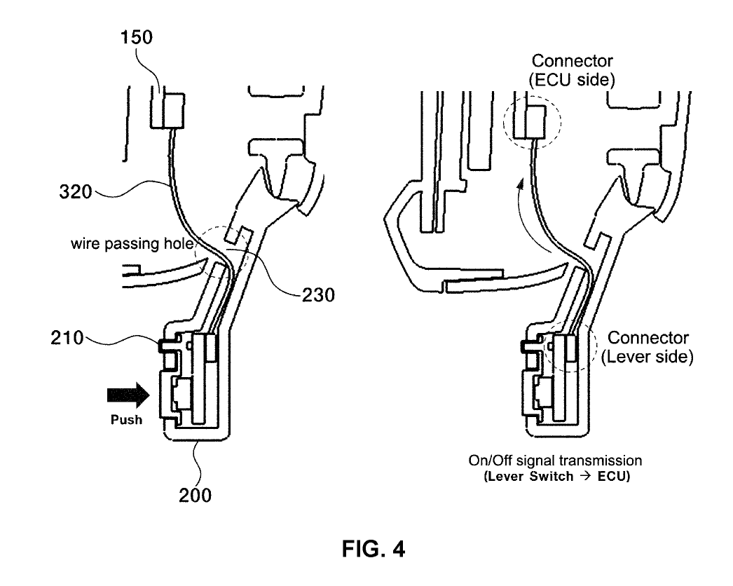

FIG. 4 is a sectional view illustrating the configuration of the tilting lever of the lever type display mirror 100 according to an exemplary embodiment of the present invention.

As illustrated in FIG. 4, the tilting lever including the first switch 200 is configured to connect the control device 150 with the wire 220. A wire passing hole 230 is located in the tilting lever to connect the wire 220 to an internal of the housing 110.

The control device 150 is configured to receive the input of the first switch 200 through the wire passing hole 230, thus controlling the activation of the display function.

The configuration of the first switch 200 including a push type switch is included in an exemplary embodiment of the invention. A connector is provided between the first switch 200 and the wire 220 to be electrically connected to the control device 150.

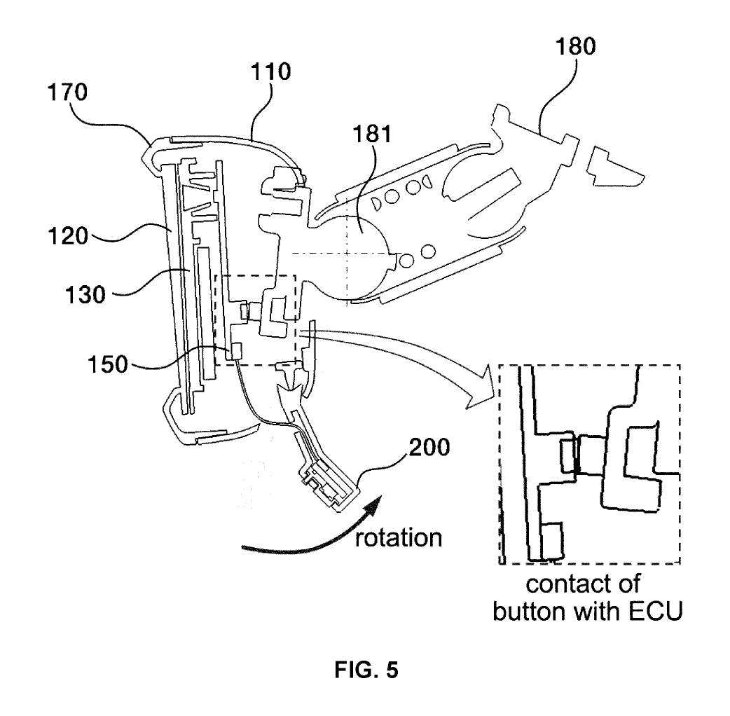

FIG. 5 illustrates a state of the second switch 300 which is changed as the tilting lever rotates, according to the exemplary embodiment of the present invention.

As illustrated in FIG. 5, according to the embodiment of the invention, the tilting lever is rotated to the front of the vehicle so that the housing 110 of the inside mirror 120 is tilted. Thus, the second switch 300 provided in the housing 110 to be fixed to a position corresponding to the mounting 180 is in contact with the circuit board in the tilted housing 110 and then is changed to the ON state.

That is, in FIG. 5, when the second switch 300 is a push- or contact-type switch, the housing 110 including the circuit board is configured to be tilted and come into contact with the second switch 300, thus applying power to the display panel 130. Power may be applied to the illumination device 210 to turn on the illumination. The illumination device 210 located in the tilting lever may change an illumination color depending on the first switch 200. Only when the second switch 300 is applied, a white color is lighted. When the first switch 200 and the second switch 300 are in the ON state, a green color is lighted.

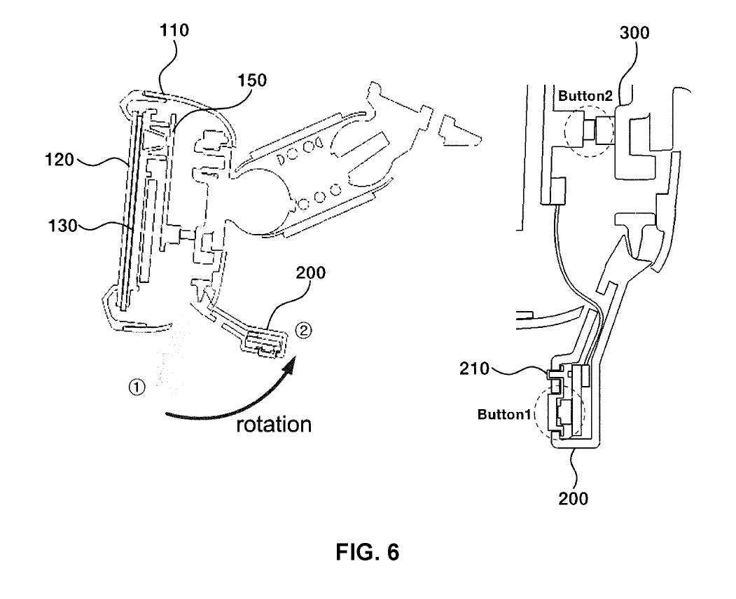

FIG. 6 illustrates a side sectional view of the lever type display mirror 100, when the first switch 200 and the second switch are in the ON state, according to the exemplary embodiment of the present invention.

When the reflective surface of the mirror 120 is tilted by manipulating the tilting lever and thus the display mirror is changed to the night mode, the second switch 300 located integrally with the mounting 180 is changed to the ON state. When the second switch 300 is changed to the ON state, power is applied to the display panel 130.

When the second switch 300 is turned on and the first switch 200 is changed to the ON state, the image captured by the rear camera of the vehicle is displayed on the display panel 130. When the first switch 200 is changed to the ON state, the control device 150 converts an image captured by a super-wide-angle rear camera into a rear image formed by the inside mirror 120, and performs the correction of the distorted image.

Therefore, the image of the rear camera capturing the super-wide-angle image is corrected through the control device 150 to be equal to the rear view of the inside mirror 120, and then is displayed on the display panel 130.

Moreover, depending on the state of the first switch 200 and the second switch 300, the day/night mode of the mirror 120, the EC function of the mirror 120, the operation of the illumination device 210 and the operation of the display window 121 are shown in the following table 1.

TABLE 1

| | | Function | | | |
|---|---|---|---|---|---|
| Switch conversion | | | Night | Lever | |
| Second | | | (display | illumination | |
| switch | First switch | Tilting | window) | unit | EC function |
| off | off | day | off | off | on |
| on | off | night | on | on (white) | off |
| on | on | night | off | on (green) | off |
| off | on | day | off | off | on |

Accordingly, the ON/OFF state of the second switch 300 is set depending on the state of the tilting lever. When the second switch 300 is in the ON state, the mirror 120 is changed to the night mode and the EC function is released.

When the second switch 300 is in the ON state and the first switch 200 is in the OFF state, the display window 121 formed in a portion of the mirror 120 by etching is turned on, and power is applied to the display panel 130. The display window 121 displays such that the reflective surface of the mirror 120 is in the night mode, in the state where power is applied to the display panel 130.

Furthermore, when the second switch 300 is in the ON state and the first switch 200 is changed to the ON state, the image is displayed on the display panel 130.

However, in the state where the second switch 300 is off, regardless of the state of the first switch 200, the mirror 120 is changed to the day mode, the EC function is activated, and the display window 121 and the illumination device 210 maintain the OFF state.

That is, power is applied to the display panel 130, the display window 121 and the illumination device 210 by the first switch 200. Thus, when the first switch 200 is in the OFF state regardless of the state of the second switch 300, each of the display panel 130, the display window 121 and the illumination device 210 is not operated.

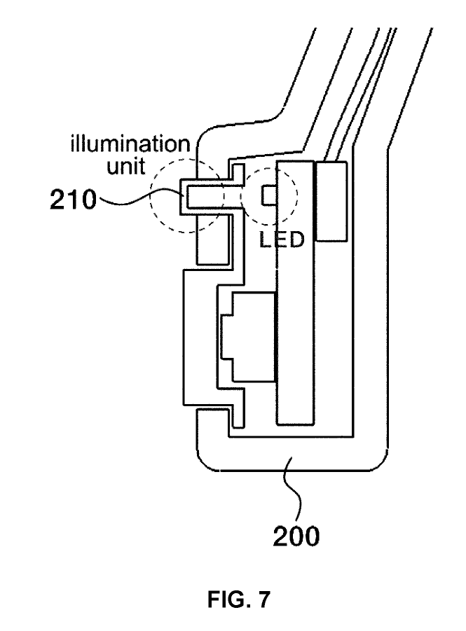

FIG. 7 is a sectional view illustrating the illumination device 210 located at an end portion of the first switch 200 according to the exemplary embodiment of the present invention.

According to the embodiment of the invention, when the first switch 200 is set to be in the OFF state and the second switch 300 is set to be in the OFF state, the illumination device 210 is turned on. In the state where power is applied to the display panel 130, a white LED is turned on. Furthermore, when the first switch 200 and the second switch 300 are converted into the ON state to display an image on the display panel 130, the illumination device 210 is configured to turn on a green LED.

However, the configuration of the LED which is turned on in the illumination device 210 to have different colors depending on the state of the first switch 200 may change a color according to a user's setting.

The present invention may achieve the following effects by the above-described embodiments, configuration, coupling and relationship.

The invention has the effect of increasing the visibility of an inside mirror by eliminating an overlapped image.

Furthermore, the invention has the effect of shielding a user's eyes against a glare by applying a tilting function and minimizing light reflected through a mirror in a display mode.

For convenience in explanation and accurate definition in the appended claims, the terms “upper”, “lower”, “internal”, “outer”, “up”, “down”, “upper”, “lower”, “upwards”, “downwards”, “front”, “rear”, “back”, “inside”, “outside”, “inwardly”, “outwardly”, “internal”, “external”, “internal”, “outer”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described to explain certain principles of the invention and their practical application, to enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A lever type display mirror apparatus comprising:
a housing fixedly located in a windshield glass;
a mirror located in the housing;
a display panel located on a rear of the mirror, and receiving a signal of a rear camera to display a rear image; and
a tilting lever adjusting an angle of a reflective surface of the mirror to be converted into a day mode and a night mode,
wherein a first switch is provided on an end portion of the tilting lever to display the rear image on the display panel, and a second switch is provided to apply power to the display panel when the tilting lever is tilted.

2. The display mirror apparatus of claim 1, further including:
a controller located in the housing to drive the display panel.

3. The display mirror apparatus of claim 2, further including:
a wire connecting the first switch with the controller, the wire being inserted into a wire passing hole of the tilting lever.

4. The display mirror apparatus of claim 1, wherein power is applied to the display panel, when the tilting lever is tilted to turn on the second switch.

5. The display mirror apparatus of claim 1, wherein the mirror is converted into the night mode, when the tilting lever is tilted to turn on the second switch.

6. The display mirror apparatus of claim 1, wherein the signal of the rear camera is received and the rear image is displayed on the display panel, when the first and second switches are turned on.

7. The display mirror apparatus of claim 1, further including:
a display window located in a portion of the mirror,
wherein the display window is configured to display a mode of the mirror depending on a position of the tilting lever.

8. The display mirror apparatus of claim 1, further including:
an illumination device located in the tilting lever,
wherein the illumination device is turned on in different colors depending on a state of the first switch, when the second switch is ON.

9. The display mirror of claim 1, further including:
a bezel snap-fitted apparatus along an opening of the housing.

10. The display mirror apparatus of claim 9, further including:
an attachment plate located in the housing to fix the mirror, the display panel and the bezel.

11. The display mirror apparatus of claim 1, further including:
an ETC (Electronic Toll Collection) module located on a side of the housing.

12. The display mirror apparatus of claim 1, wherein the mirror includes an ECM (Electronic Chromic Mirror) mirror having an EC (electronic chromic) function.

13. The display mirror apparatus of claim 12, further including:
an illumination detector located in the housing, the illumination detector determining an intensity of illumination introduced into the mirror and controlling a reflectivity of the mirror.

14. The display mirror apparatus of claim 12, wherein the EC function of the mirror is released, when the tilting lever is tilted to turn on the second switch.

15. The display mirror apparatus of claim 1, wherein the display panel includes at least one of LCD, LED, OLED, plasma, and DLP display elements.
